(19) United States
(12) Patent Application Publication
(10) Pub. No.: US 2013/0272099 A1
(43) Pub. Date: Oct. 17, 2013

(54) ELECTRONIC DEVICE, TIME CALIBRATION SYSTEM AND METHOD

(71) Applicant: FENG-CHI YANG, Tu-Cheng (TW)

(72) Inventor: FENG-CHI YANG, Tu-Cheng (TW)

(21) Appl. No.: 13/660,972

(22) Filed: Oct. 25, 2012

(30) Foreign Application Priority Data
Apr. 16, 2012 (CN) 201210109930.1

(51) Int. Cl. G04G 7/00; G04G 7/02

(52) U.S. Cl. 368/13; 368/46; 368/47; 368/10

(57) ABSTRACT

A time calibration method includes steps: establishing a connection between the electronic device and the communication device. A trigger signal is produced to the communication device in response to the operation of the user triggering the communication device to update the time of the communication device. The time provided by the electronic device is obtained and compared to the time provided by the communication device. The time of the electronic device is calibrated according to the updated time of the communication device if the difference between the time provided by the electronic device and the updated time provided by the communication device is greater than a predetermined value.

### BACKGROUND

1. Technical Field

The present disclosure relates to electronic devices, and particularly to an electronic device capable of utilizing a communication device to calibrate its time, and time calibration system and method.

2. Description of Related Art

Electronic devices, such as mobile phones, digital cameras, electronic readers, digital photo frames, usually have a real time clock (RTC) for providing time information. The time of the electronic device should be calibrated at intervals. One common method of calibrating the time of the electronic device is manual calibration, typically, the user manually calibrates the time of the electronic device according to a standard time provided by a TV station or a broadcasting station. However, it is difficult to calibrate the time precisely by manual operation. Another method to calibrate the time of the electronic device is to connect the electronic device to a server via network, and then calibrate the time of the electronic device automatically by obtaining the standard time from the server via a corresponding program. However, if the electronic device cannot connect to the server, then the electronic device cannot calibrate its time by this method.

Therefore, an electronic device, a time calibration system and method, to overcome the described limitations are thus needed.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of a time calibration system including an electronic device and a communication device, in accordance with an exemplary embodiment.

FIG. 2 is flowchart illustrating a time calibration method, applied in a time calibration system, such as that of FIG. 1, in accordance with an exemplary embodiment.

### DETAILED DESCRIPTION

Embodiments of the present disclosure will be described with reference to the accompanying drawings.

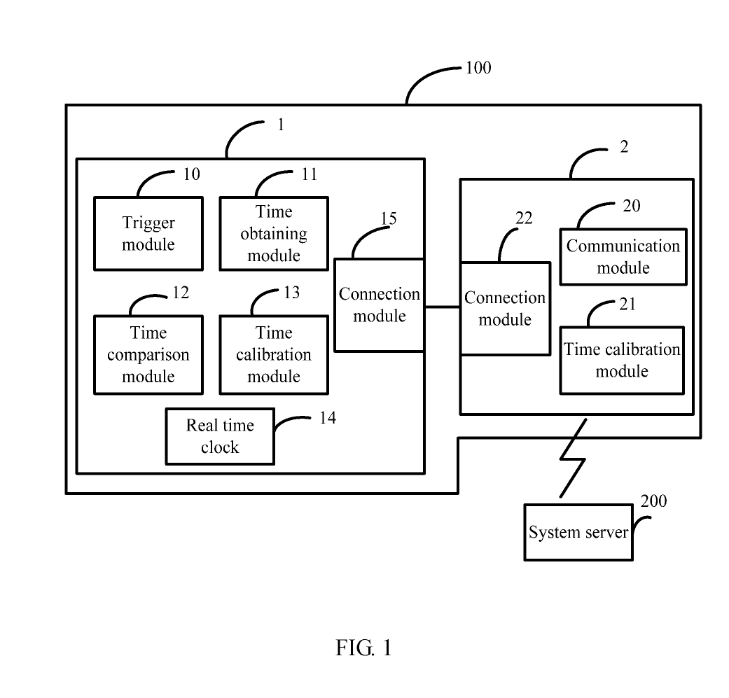

FIG. 1 illustrates an embodiment of a time calibration system 100. The time calibration system 100 includes an electronic device 1 needing to be calibrated and a communication device 2. The electronic device 1 can calibrate its time via the communication device 2.

As shown in FIG. 1, the electronic device 1 includes a trigger module 10, a time obtaining module 21, a time comparison module 12, a time calibration module 13, a real time clock (RTC) 14, and a connection module 15.

The RTC 14 provides system time for the electronic device 1. The connection module 15 is used to connect to the communication device 2. The connection module 15 can be a wired port, such as, a USB port, a PS/2 port, and an iEEE1394 port. The connection module 15 also can be a wireless communication module, such as a WIFI module, a BLUETOOTH module.

The trigger module 10 is used to provide a trigger signal to the communication device 2 via the connection module 15 in response to user's operation, after the electronic device 1 has connected to the communication device 2 via the connection module 15. Then the communication device 2 is triggered to update its time via obtaining a standard time from a system server 200.

In the embodiment, the user can operate a menu or a preset button to cause the trigger module 10 to produce the trigger signal.

The time obtaining module 11 is used to obtain the time provided by the RTC 14 and the updated time provided by the communication device 2. The time comparison module 12 is used to compare the time provided by the RTC 14 and the updated time provided by the communication device 2.

The time calibration module 13 is used to calibrate the time of the RTC 14 according to the updated time provided by the communication device 2. If the time comparison module 12 evaluates a difference between the time provided by the RTC 14 and the updated time provided by the communication device 2 is greater than a predetermined value, such as 2 seconds. In the embodiment, the time calibration module 13 calibrates the time of the RTC 14 to accord with the updated time provided by the communication device 2.

As shown in FIG. 1, the communication device 2 includes a communication module 20, a time calibration module 21, and a connection module 22. In the embodiment, the communication device 2 can be a mobile phone, and the system server 200 can be a network server, a telephony server, for example.

The connection module 22 is used to communicate with the connection module 15 and establish the connection between the electronic device 1 and the communication device 2 via the operation of the user. The time calibration module 21 is used to receive the trigger signal from the trigger module 10, in addition, connects to the system server 200 via the communication device 2, and obtains the standard time from the system server 200, and then calibrates/updates its time according to the standard time.

Then the electronic device 1 obtains the updated time from the communication device 2 and calibrates the time of the electronic device 1 as described above. Namely, the time obtaining module 11, the time comparison module 12, and the time calibration module 13 execute their functions as described above to calibrate the time of the electronic device 1.

In the embodiment, the electronic device 1 can be a mobile phone, a digital camera, a digital photo frame, a tablet computer, for example. The connection module 22 can be a wired port, such as, a USB port, a PS/2 port, and an iEEE1394 port. The connection module 22 also can be a wireless communication module, such as a WIFI module, a BLUETOOTH module. The communication module 23 can be a wireless communication module which connects the system server 200 via a global system for mobile communication network, or a general packet radio service network.

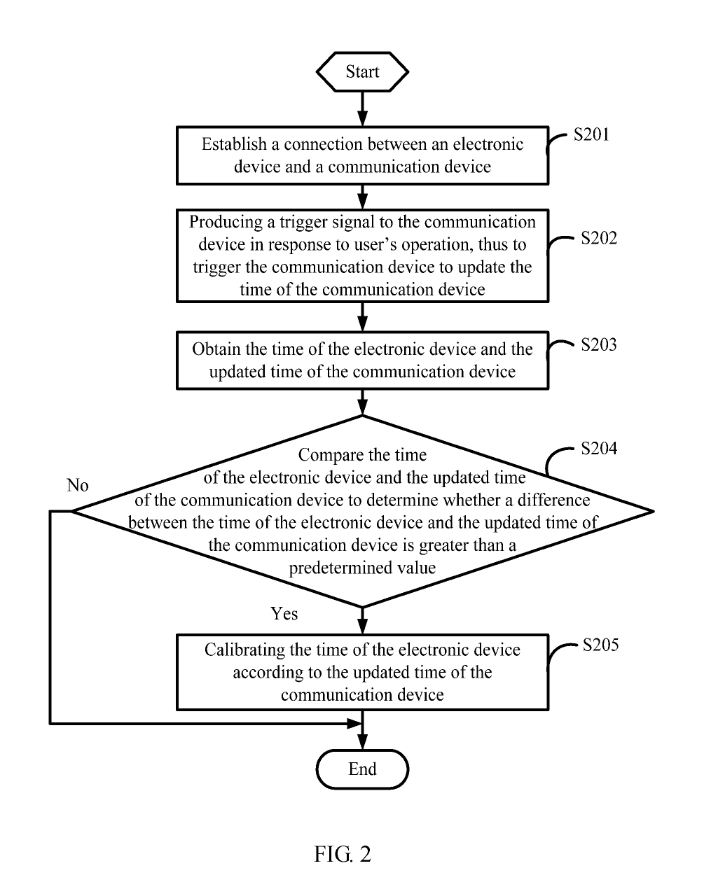

Referring to FIG. 2, a flowchart illustrating a time calibration method is shown. The method is applied in the time calibration system 100 as shown in FIG. 1. In step S201, the connection between the electronic device 1 and the communication device 2 is established in response to the operation of the user.

In step S202, the trigger module 10 produces a trigger signal to the communication device 2 in response to the operation of the user to trigger the communication device 2 to update the time of the communication device 2 via obtaining a standard time from a system server 200.

In step S203, the time obtaining module 11 obtains the time provided by the RTC 14 and the updated time provided by the communication device 2.

In step S204, the time comparison module 12 compares the time provided by the RTC 14 and the updated time provided by the communication device 2, and determines whether a difference between the time provided by the RTC 14 and the updated time provided by the communication device 2 is greater than a predetermined value.

If the difference between the time provided by the RTC 14 and the updated time provided by the communication device 2 is not greater than a predetermined value, the procedure is ended, otherwise, in step S205, the time calibration module 13 calibrates the time of the RTC 14 according to the updated time of the communication device 2. In the embodiment, the time calibration module 13 calibrates the time of the RTC 14 to accord with the updated time of the communication device 2.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device comprising:
a real time clock (RTC), configured to provide system time for the electronic device;
a connection module, configured to connect to a communication device;
a trigger module, configured to produce a trigger signal to the communication device via the connection module in response to user's operation, thus to trigger the communication device to obtain a standard time from a system server to update time of the communication device according to the obtained standard time;
a time obtaining module, configured to obtain the time provided by the RTC and the updated time provided by the communication device;
a time comparison module, configured to compare the time provided by the RTC and the updated time provided by the communication device; and
a time calibration module, configured to calibrate the time of the RTC according to the updated time of the communication device, when the time comparison module evaluates a difference between the time provided by the RTC and the updated time provided by the communication device is greater than a predetermined value.

2. The electronic device according to claim 1, wherein the time calibration module calibrates the time of the RTC to accord with the update time of the communication device.

3. The electronic device according to claim 1, wherein, the connection module is one selected from a group consist of a USB port, a PS/2 port, an iEEE1394 port, a WIFI module, and a BLUETOOTH module.

4. The electronic device according to claim 1, wherein the electronic device is one selected from a group consist of a mobile phone, a digital camera, a digital photo frame, and a tablet computer.

5. A time calibration system, comprising:
a communication device comprising:
a communication module, configured to communicate with a system server;
a first connection module; and
a first time calibration module, configured to connect to the system server via the communication device when receiving a trigger signal, and obtain a standard time from the system server, and update time of the communication device according to the standard time; and
an electronic device, comprising:
a real time clock (RTC), configured to provide system time for the electronic device;
a second connection module, configured to connect to the first connection module of the communication device;
a trigger module, configured to produce the trigger signal to the communication device via the connection module in response to user's operation;
a time obtaining module, configured to obtain the time provided by the RTC and the updated time provided by the communication device;
a time comparison module, configured to compare the time provided by the RTC and the updated time provided by the communication device; and
a second time calibration module, configured to calibrate the time of the RTC according to the updated time of the communication device, when the time comparison module evaluates a difference between the time provided by the RTC and the updated time provided by the communication device is greater than a predetermined value.

6. The system according to claim 5, wherein the second time calibration module calibrate the time of the RTC to accord with the update time of the communication device.

7. The system according to claim 5, wherein the first connection module is one selected from a group consist of a USB port, a PS/2 port, an iEEE1394 port, a WIFI module, and a BLUETOOTH module.

8. The system according to claim 5, wherein the second connection module is one selected from a group consist of a USB port, a PS/2 port, an iEEE1394 port, a WIFI module, and a BLUETOOTH module.

9. The system according to claim 5, wherein the electronic device is one selected from a group consist of a mobile phone, a digital camera, a digital photo frame, and a tablet computer.

10. The system according to claim 5, wherein the communication device is a mobile phone.

11. A time calibration method for calibrating time of an electronic device via a communication device, the method comprising:
establishing a connection between the electronic device and the communication device;
producing a trigger signal to the communication device in response to user's operation to trigger the communication device to obtain a standard time from a system server and update the time of the communication device according to the standard time from a system server;
obtaining the time provided by the electronic device and the updated time provided by the communication device;
comparing the time provided by the electronic device and the updated time provided by the communication device to determine whether a difference between the time provided by the electronic device and the updated time provided by the communication device is greater than a predetermined value; and
calibrating the time of the electronic device according to the updated time of the communication device if the difference between the time provided by the electronic device and the updated time provided by the communication device is greater than a predetermined value.

12. The method according to claim 11, wherein the step of “calibrating the time of the electronic device according to the updated time of the communication device” comprises:
calibrating the time of the electronic device to accord with the updated time of the communication device.
